(19) United States
(12) Patent Application Publication
(10) Pub. No.: US 2018/0293928 A1
(43) Pub. Date: Oct. 11, 2018

(54) DRIVING CIRCUIT AND LIQUID CRYSTAL DISPLAY DEVICE THEREOF

(71) Applicant: SHENZHEN CHINA STAR OPTOELECTRONICS TECHNOLOGY CO., LTD., Shenzhen, Guangdong (CN)

(72) Inventors: Yuyeh CHEN, Shenzhen, Guangdong (CN); Jhenwei HE, Shenzhen, Guangdong (CN); Yu WU, Shenzhen, Guangdong (CN); Tao HE, Guangdong (CN)

(21) Appl. No.: 15/522,245

(22) PCT Filed: Mar. 17, 2017
(86) PCT No.: PCT/CN2017/077093

§ 371 Date: Apr. 26, 2017

(30) Foreign Application Priority Data
Feb. 28, 2017 (CN) 201710113327.3

(51) Int. Cl. G09G 3/20; G09G 3/36

(52) U.S. Cl. CPC G09G 3/2007; G09G 3/3685; G09G 3/3674; G09G 2320/0666; G09G 2330/021; G09G 2310/08; G09G 2320/0276

(57) ABSTRACT

A driving circuit and a liquid crystal display device hereof are described. The driving circuit includes a source driving chip to convert the video signal into a plurality of gray scale voltages. A relationship between the brightness and the gray scales of the display panel and a relationship between the brightness and the voltages of the display panel in a predetermined gamma curve are pre-acquired. The source driving chip obtains a string of resistance values based on a relationship between the brightness and the gray scales and a relationship between the brightness and the voltages. The data signal is then generated according to the data control voltage, the first timing control signal, the video signal and the string of resistance values.

### BACKGROUND OF THE INVENTION

### Field of Invention

The present invention relates to a technical field of displays, and more particularly relates to a driving circuit and a liquid crystal display device thereof.

### Description of Prior Art

At present, a driving circuit of a liquid crystal display panel includes a programmable gamma correction buffer chip 11, a timing control chip 12, a power management chip 13, a source driver chip 14, and a gate driving chip 15, where a programmable gamma correction buffer chip 11 provides a reference voltage, which has a range from zero to fourteen (volts, V) requiring the number of 14 gray scale reference voltages, the positive polarity and the negative polarity are each half, and typically reference voltages of gray scales 0, 1, 31, 127, 223, 254, 255 provided.

The gray scale and brightness of the panel are required to satisfy a predetermined relationship curve in order to achieve the optimal visual effect to the human eye, and typically, a gamma value of 2.2 is the better visual effect.

A voltage-dividing module is built in a source driving chip 14 is configured to divide an initial voltage VAA of the power management chip 13 into a number of 256 voltages may be provided from initial voltage VAA the 256 where the number of 256 voltages corresponds to the gray scale from 0 to 255. When the source drive chip 14 receives the initial voltage VAA but accepts no reference voltage input, a set of gray-scale voltage values linearly proportional to a resistance value is generated and it is generally difficult to satisfy each gray scale in the gamma 2.2 curve. When a reference voltage is inputted to the source driving chip 14, the reference voltage value is adjusted so that the brightness of each gray scale satisfies the relationship of gamma 2.2, and a voltage in each gray scale obtains a corresponding gray scale voltage by a resistance divisional voltage, which allows a full gray scale substantially in the vicinity of the curve gamma 2.2.

Since the conventional driving circuit is required to set a programmable gamma correction buffer chip 11, thereby increasing the production cost.

Accordingly, there is a need to provide a drive circuit and a liquid crystal display device to solve the problems of the prior art.

### SUMMARY OF THE INVENTION

Therefore, one objective of the present invention is to provide a driving circuit and a liquid crystal display device thereof for simplifying the structure of the driving circuit and reducing the manufacturing cost.

Based on the above objective, the present invention sets forth a driving circuit comprising a power management chip, configured to generate data control voltages and scanning control voltages; a timing control chip, configured to provide a first timing control signal, a video signal, and a second timing control signal, and to provide a white balance adjustment table for adjusting a data signal according to the white balance adjustment table to optimize a gamma curve; a source driving chip, configured to convert the video signal into a plurality of gray scale voltages and to pre-acquire a relationship between a brightness and gray scales of a display panel and a relationship between the brightness and voltages of the display panel in a predetermined gamma curve, wherein the source driving chip obtains a string of resistance values based on a relationship between the brightness and the gray scales and a relationship between the brightness and the voltages, and the data signal is generated according to the data control voltages, the first timing control signal, the video signal and the string of resistance values so that a display effect of the display panel meets a predetermined requirement; and a gate driving chip, configured to generate a scanning signal according to the scanning control voltages and the second timing control signal.

In one embodiment, the source driving chip acquires a relationship between the gray scales and the voltages after a voltage division is generated based on a relationship between the brightness and the gray scales and based on the relationship between the brightness and the voltages, and the source driving chip obtains the string of resistance values based on relationship between the brightness and the gray scales after the voltage division is generated.

In one embodiment, the power management chip comprises a first output terminal, the timing control chip comprises a second output terminal, the gate driving chip comprises a first input terminal and a second input terminal, the first input terminal connects to the first output terminal, and the second input terminal connects to the second output terminal.

In one embodiment, the power management chip comprises a first output terminal, the source driving chip comprises a third input terminal and a fourth input terminal, the third input terminal connects to the first output terminal, and the fourth input terminal connects to the second output terminal.

The present invention further provides a driving circuit, comprising a power management chip, configured to generate data control voltages; a timing control chip, configured to provide a first timing control signal and a video signal; and a source driving chip, configured to convert the video signal into a plurality of gray scale voltages and to pre-acquire a relationship between a brightness and gray scales of a display panel and a relationship between the brightness and voltages of the display panel in a predetermined gamma curve, wherein the source driving chip acquires a relationship between the gray scales and the voltages after a voltage division is generated based on a relationship between the brightness and the gray scales and based on the relationship between the brightness and the voltages, and the source driving chip obtains the string of resistance values based on relationship between the brightness and the gray scales after the voltage division is generated, and wherein the data signal is generated according to the data control voltages, the first timing control signal, the video signal and the string of resistance values so that a display effect of the display panel meets a predetermined requirement.

In one embodiment, the timing control chip is further configured to provide a white balance adjustment table for adjusting a data signal according to the white balance adjustment table to optimize a gamma curve.

In one embodiment, the driving further comprises a gate driving chip, wherein the power management chip is further configured to scanning control voltages, wherein the timing control chip is further configured to provide a second timing control signal, and wherein the gate driving chip is configured to generate a scanning signal according to the scanning control voltages and the second timing control signal.

In one embodiment, the power management chip comprises a first output terminal, the timing control chip comprises a second output terminal, the gate driving chip comprises a first input terminal and a second input terminal, the first input terminal connects to the first output terminal, and the second input terminal connects to the second output terminal.

In one embodiment, the power management chip comprises a first output terminal, the source driving chip comprises a third input terminal and a fourth input terminal, the third input terminal connects to the first output terminal, and the fourth input terminal connects to the second output terminal.

The present invention also provides a liquid crystal display device comprising a liquid crystal display panel and a driving circuit, the driving circuit comprising a power management chip, configured to generate data control voltages; a timing control chip, configured to provide a first timing control signal and a video signal; and a source driving chip, configured to convert the video signal into a plurality of gray scale voltages and to pre-acquire a relationship between a brightness and gray scales of a display panel and a relationship between the brightness and voltages of the display panel in a predeteimined gamma curve, wherein the source driving chip acquires a relationship between the gray scales and the voltages after a voltage division is generated based on a relationship between the brightness and the gray scales and based on the relationship between the brightness and the voltages, and the source driving chip obtains the string of resistance values based on relationship between the brightness and the gray scales after the voltage division is generated, and wherein the data signal is generated according to the data control voltages, the first timing control signal, the video signal and the string of resistance values so that a display effect of the display panel meets a predetermined requirement.

In one embodiment, the timing control chip is further configured to provide a white balance adjustment table for adjusting a data signal according to the white balance adjustment table to optimize a gamma curve.

In one embodiment, the driving further comprises a gate driving chip, wherein the power management chip is further configured to scanning control voltages, wherein the timing control chip is further configured to provide a second timing control signal, and wherein the gate driving chip is configured to generate a scanning signal according to the scanning control voltages and the second timing control signal.

In one embodiment, the power management chip comprises a first output terminal, the timing control chip comprises a second output terminal, the gate driving chip comprises a first input terminal and a second input terminal, the first input terminal connects to the first output terminal, and the second input terminal connects to the second output terminal.

In one embodiment, the power management chip comprises a first output terminal, the source driving chip comprises a third input terminal and a fourth input terminal, the third input terminal connects to the first output terminal, and the fourth input terminal connects to the second output terminal.

In the driving circuit and liquid crystal display device of the present invention, since there is no need for a programmable gamma correction buffer chip to provide a reference voltage, the source driving chip obtains a string of resistance values according to the relationship between the brightness and the gray scales and a relationship between the brightness and the voltages. The relation between the brightness and the gray scales of the display panel satisfies the requirement of a curve of gamma value 2.2, thus simplifying the structure of the driving circuit and reducing the manufacturing cost.

### BRIEF DESCRIPTION OF THE DRAWINGS

FIG. 1 is a schematic structural diagram of a conventional driving circuit;

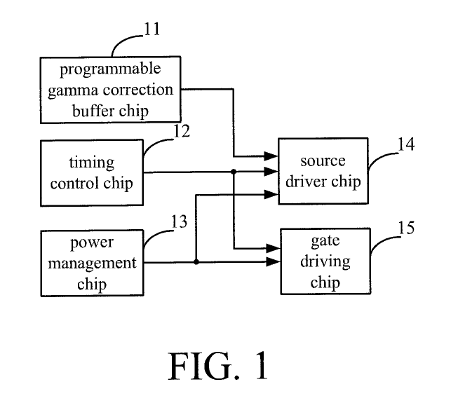

FIG. 2 is a schematic structural diagram of a driving circuit according to one embodiment of the present invention;

FIG. 3 is a graph illustrating the brightness and the gray scales according to one embodiment of the present invention;

FIG. 4 is a graph illustrating the brightness and the voltages according to one embodiment of the present invention; and

FIG. 5 is a graph illustrating the gray scales and the voltages according to one embodiment of the present invention.

### DETAILED DESCRIPTION OF THE PREFERRED EMBODIMENTS

The following embodiments refer to the accompanying drawings for exemplifying specific implementable embodiments of the present invention. Furthermore, directional terms described by the present invention, such as upper, lower, front, back, left, right, inner, outer, side, etc., are only directions by referring to the accompanying drawings, and thus the used directional terms are used to describe and understand the present invention, but the present invention is not limited thereto. In the drawings, the same reference symbol represents the same or a similar component.

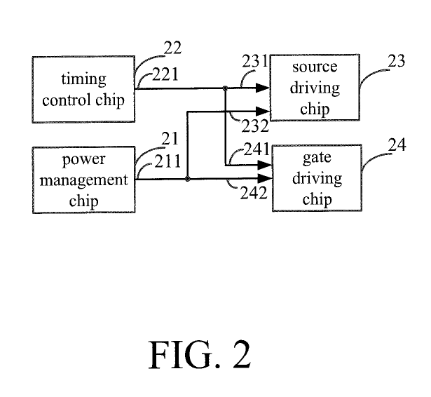

Referring to FIG. 2, FIG. 2 is a schematic structural diagram of a driving circuit according to one embodiment of the present invention.

As shown in FIG. 2, the driving circuit of the present invention includes a power management chip 21, a timing control chip 22, and a source driving chip 23. The power management chip 21 is configured to generate data control voltages, such as VAA and HVAA.

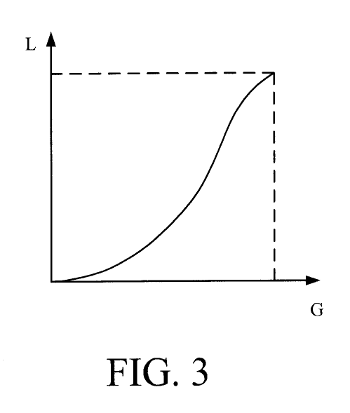

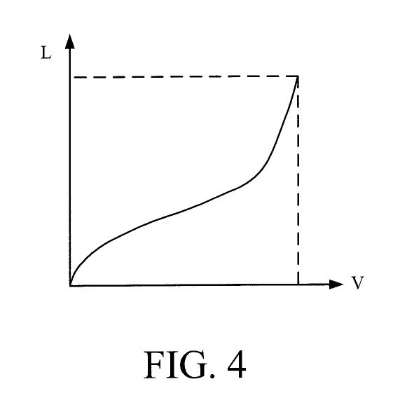

The timing control chip 22 is used to provide a first timing control signal and a video signal. The source driving chip 23 is used to convert the video signal into a plurality of gray scale voltages for providing the gray scale voltages to the display panel at a predetermined timing. A relationship between the brightness and the gray scales of the display panel and a relationship between the brightness and the voltages of the display panel in a predetermined gamma curve (e.g., a curve of gamma value 2.2) are pre-acquired. FIG. 3 shows a graph of the brightness and the gray scales, where a horizontal axis represents the gray scales and a vertical axis represents the brightness. FIG. 4 shows a graph of the brightness and the voltages, where a horizontal axis represents the voltages and a vertical axis represents the brightness.

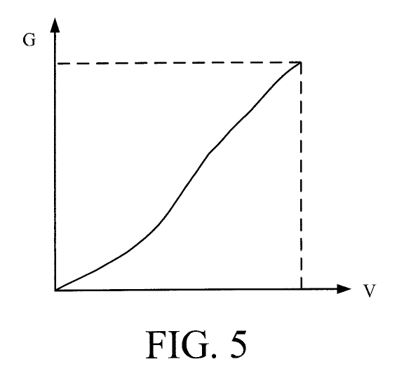

Afterwards, the source driving chip 23 acquires a relationship between the gray scales and voltages after a voltage division is generated according to the relationship between the brightness and the gray scales and a relationship between the brightness and the voltages. FIG. 5 shows a graph of the gray scales and the voltages, where a horizontal axis represents the voltages and a vertical axis represents the gray scales. Finally, the source driving chip 23 obtains a string of resistance values based on a proportional relationship between the gray scales and voltages after the voltage division is generated, where the string of resistance values is configured to correct a string of resistance values built in the source driving chip 23. The data signal is then generated according to the data control voltage, the first timing control signal, the video signal and the string of resistance values so that a display effect of the display panel meets a predetermined requirement, such as an optimal visual effect of the human eyes.

In order to further enhance the visual effect of the human eyes, the timing control chip 22 is also used to provide a white balance adjustment table (WT table) and to adjust the data signal according to the white balance adjustment table. In embodiment, when the brightness offset of the display panel occurs during a manufacturing process, the data signal is adjusted based on the WT table so that the gamma curve of the display panel meets the requirements.

The driving circuit of the present invention further includes a gate driving chip 24 and the power supply management the chip 21 is also used to generate the scanning control voltages, such as VGH and VGL. The timing control chip 22 is also used to provide the second timing control signal. The gate driving chip 24 generate a scanning signal according to the scanning control voltages and the second timing control signal.

The power management chip 21 includes a first output terminal 211, the timing control chip 22 includes a second output terminal 221, the gate driving chip 23 includes a first input terminal 232 and the second input terminal 231, where the first input terminal 232 connects to the first output terminal 211, and the second input terminal 231 connects to the second output terminal 221.

The source driving chip 24 includes a third input terminal 242 and a fourth input terminal 241, where the third input terminal 242 connects to the first output terminal 211, and the fourth input terminal 241 connects to the second output terminal 221.

In the driving circuit of the present invention, since there is no need for a programmable gamma correction buffer chip to provide a reference voltage, the source driving chip 23 acquires a relationship between the gray scales and voltages in the predetermined gamma curve after a voltage division is generated according to the relationship between the brightness and the gray scales and a relationship between the brightness and the voltages. The source driving chip 23 obtains a string of resistance values based on a relationship between the gray scales and voltages after the voltage division is generated so that the relation between the brightness and the gray scales of the display panel satisfies the requirement of a curve of gamma value 2.2, thus simplifying the structure of the driving circuit and reducing the manufacturing cost.

The present invention also provides a liquid crystal display device including a liquid crystal display panel and a driving circuit, as shown in FIG. 2. The driving circuit of the present invention includes the power management chip 21, a timing control chip 22, and a source driving chip 23. The power management chip 21 is used to generate the control voltage data, such as VAA and HVAA.

The timing control chip 22 is used to provide a first timing control signal and a video signal. The source driving chip 23 is used to convert the video signal into a plurality of gray scale voltages for providing the gray scale voltages to the display panel at a predetermined timing. A relationship between the brightness and the gray scales of the display panel and a relationship between the brightness and the voltages of the display panel in a predetermined gamma curve (e.g., a curve of gamma value 2.2) are pre-acquired. FIG. 3 shows a graph of the brightness and the gray scales. FIG. 4 shows a graph of the brightness and the voltages.

Afterwards, the source driving chip 23 acquires a relationship between the gray scales and voltages after a voltage division is generated according to the relationship between the brightness and the gray scales and a relationship between the brightness and the voltages. Finally, the source driving chip 23 obtains a string of resistance values based on a proportional relationship between the gray scales and voltages after the voltage division is generated, where the string of resistance values is configured to correct a string of resistance values built in the source driving chip 23. The data signal is then generated according to the data control voltage, the first timing control signal, the video signal and the string of resistance values so that a display effect of the display panel meets a predetermined requirement, such as an optimal visual effect of the human eyes.

In order to further enhance the visual effect of the human eyes, the timing control chip 22 is also used to provide a white balance adjustment table (WT table) and to adjust the data signal according to the white balance adjustment table. In embodiment, when the brightness offset of the display panel occurs during a manufacturing process, the data signal is adjusted based on the WT table so that the gamma curve of the display panel meets the requirements.

The driving circuit of the present invention further includes a gate driving chip 24 and the power supply management the chip 21 is also used to generate the scanning control voltages, such as VGH and VGL. The timing control chip 22 is also used to provide the second timing control signal. The gate driving chip 24 generate a scanning signal according to the scanning control voltages and the second timing control signal.

The power management chip 21 includes a first output terminal 211, the timing control chip 22 includes a second output terminal 221, the gate driving chip 23 includes a first input terminal 232 and the second input terminal 231, where the first input terminal 232 connects to the first output terminal 211, and the second input terminal 231 connects to the second output terminal 221.

The source driving chip 24 includes a third input terminal 242 and a fourth input terminal 241, where the third input terminal 242 connects to the first output terminal 211, and the fourth input terminal 241 connects to the second output terminal 221.

In the liquid crystal display device of the present invention, since there is no need for a programmable gamma correction buffer chip to provide a reference voltage, the source driving chip 23 acquires a relationship between the gray scales and voltages in the predetermined gamma curve after a voltage division is generated according to the relationship between the brightness and the gray scales and a relationship between the brightness and the voltages. The source driving chip 23 obtains a string of resistance values based on a relationship between the gray scales and voltages after the voltage division is generated so that the relation between the brightness and the gray scales of the display panel satisfies the requirement of a curve of gamma value 2.2, thus simplifying the structure of the driving circuit and reducing the manufacturing cost.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

What is claimed is:

1. A driving circuit comprising:
a power management chip, configured to generate data control voltages and scanning control voltages;
a timing control chip, configured to provide a first timing control signal, a video signal, and a second timing control signal, and to provide a white balance adjustment table for adjusting a data signal according to the white balance adjustment table to optimize a gamma curve;
a source driving chip, configured to convert the video signal into a plurality of gray scale voltages and to pre-acquire a relationship between a brightness and gray scales of a display panel and a relationship between the brightness and voltages of the display panel in a predetermined gamma curve, wherein the source driving chip obtains a string of resistance values based on a relationship between the brightness and the gray scales and a relationship between the brightness and the voltages, and the data signal is generated according to the data control voltages, the first timing control signal, the video signal and the string of resistance values so that a display effect of the display panel meets a predetennined requirement; and
a gate driving chip, configured to generate a scanning signal according to the scanning control voltages and the second timing control signal.

2. The driving circuit of claim 1, wherein the source driving chip acquires a relationship between the gray scales and the voltages after a voltage division is generated based on a relationship between the brightness and the gray scales and based on the relationship between the brightness and the voltages, and the source driving chip obtains the string of resistance values based on relationship between the brightness and the gray scales after the voltage division is generated.

3. The driving circuit of claim 1, wherein the power management chip comprises a first output terminal, the timing control chip comprises a second output terminal, the gate driving chip comprises a first input terminal and a second input terminal, the first input terminal connects to the first output terminal, and the second input terminal connects to the second output terminal.

4. The driving circuit of claim 1, wherein the power management chip comprises a first output terminal, the source driving chip comprises a third input terminal and a fourth input terminal, the third input terminal connects to the first output terminal, and the fourth input terminal connects to the second output terminal.

5. A driving circuit, comprising:
a power management chip, configured to generate data control voltages;
a timing control chip, configured to provide a first timing control signal and a video signal; and
a source driving chip, configured to convert the video signal into a plurality of gray scale voltages and to pre-acquire a relationship between a brightness and gray scales of a display panel and a relationship between the brightness and voltages of the display panel in a predetermined gamma curve, wherein the source driving chip acquires a relationship between the gray scales and the voltages after a voltage division is generated based on a relationship between the brightness and the gray scales and based on the relationship between the brightness and the voltages, and the source driving chip obtains the string of resistance values based on relationship between the brightness and the gray scales after the voltage division is generated, and wherein the data signal is generated according to the data control voltages, the first timing control signal, the video signal and the string of resistance values so that a display effect of the display panel meets a predetermined requirement.

6. The driving circuit of claim 5, wherein the timing control chip is further configured to provide a white balance adjustment table for adjusting a data signal according to the white balance adjustment table to optimize a gamma curve.

7. The driving circuit of claim 5, wherein the driving further comprises a gate driving chip;
wherein the power management chip is further configured to scanning control voltages;
wherein the timing control chip is further configured to provide a second timing control signal;
wherein the gate driving chip is configured to generate a scanning signal according to the scanning control voltages and the second timing control signal.

8. The driving circuit of claim 7, wherein the power management chip comprises a first output terminal, the timing control chip comprises a second output terminal, the gate driving chip comprises a first input terminal and a second input terminal, the first input terminal connects to the first output terminal, and the second input terminal connects to the second output terminal.

9. The driving circuit of claim 5, wherein the power management chip comprises a first output terminal, the source driving chip comprises a third input terminal and a fourth input terminal, the third input terminal connects to the first output terminal, and the fourth input terminal connects to the second output terminal.

10. A liquid crystal display device comprising a liquid crystal display panel and a driving circuit, the driving circuit comprising:
a power management chip, configured to generate data control voltages;
a timing control chip, configured to provide a first timing control signal and a video signal; and
a source driving chip, configured to convert the video signal into a plurality of gray scale voltages and to pre-acquire a relationship between a brightness and gray scales of a display panel and a relationship between the brightness and voltages of the display panel in a predetermined gamma curve, wherein the source driving chip acquires a relationship between the gray scales and the voltages after a voltage division is generated based on a relationship between the brightness and the gray scales and based on the relationship between the brightness and the voltages, and the source driving chip obtains the string of resistance values based on relationship between the brightness and the gray scales after the voltage division is generated, and wherein the data signal is generated according to the data control voltages, the first timing control signal, the video signal and the string of resistance values so that a display effect of the display panel meets a predetermined requirement.

11. The liquid crystal display device of claim 10, wherein the timing control chip is further configured to provide a white balance adjustment table for adjusting a data signal according to the white balance adjustment table to optimize a gamma curve.

12. The liquid crystal display device of claim 10, wherein the driving further comprises a gate driving chip;
wherein the power management chip is further configured to scanning control voltages;
wherein the timing control chip is further configured to provide a second timing control signal;
wherein the gate driving chip is configured to generate a scanning signal according to the scanning control voltages and the second timing control signal.

13. The liquid crystal display device of claim 12, wherein the power management chip comprises a first output terminal, the timing control chip comprises a second output terminal, the gate driving chip comprises a first input terminal and a second input teiininal, the first input terminal connects to the first output terminal, and the second input terminal connects to the second output terminal.

14. The liquid crystal display device of claim 12, wherein the power management chip comprises a first output terminal, the source driving chip comprises a third input terminal and a fourth input terminal, the third input terminal connects to the first output terminal, and the fourth input terminal connects to the second output terminal.
